(19) United States
(12) Patent Application Publication
(10) Pub. No.: US 2004/0000657 A1
(43) Pub. Date: Jan. 1, 2004

(54) Device and method for closing a flow duct and pivotable shut-off and/or throttle valve

(76) Inventors: Thomas Betz, Stuttgart (DE); Johannes Leweux, Esslingen (DE); Hubert Schnuepke, Stuttgart (DE); Dietmar Schroeer, Remseck (DE)

Correspondence Address: KENYON & KENYON, ONE BROADWAY, NEW YORK, NY, 10004, US

(21) Appl. No.: 10/418,392

(22) Filed: Apr. 18, 2003

(30) Foreign Application Priority Data
Apr. 19, 2002 (DE) 102 17 468.7

(51) Int. Cl. F16K 1/22

(52) U.S. Cl. 251/305

(57) ABSTRACT

A device and a method are for closing a flow duct. The device has a valve which may be pivoted between an open position and a closed position by a valve shaft and has at least one valve wing which, in the closed position, rests against a sealing contour provided in the flow duct. The valve wing is of elastic configuration and the sealing contour or the valve wing is arranged such that first of all a region, at a distance from the valve shaft in the radial direction, of the valve wing comes into contact with the sealing contour when the valve wing is being brought into contact with the sealing contour, and that, during further pivoting of the valve shaft, the valve wing is deformed to such an extent that it rests substantially completely against the sealing contour.

### CROSS-REFERENCE TO RELATED APPLICATIONS

The present application claims priority to Application No. 102 17 468.7, filed in the Federal Republic of Germany on Apr. 19, 2002, which is expressly incorporated herein in its entirety by reference thereto.

### FIELD OF THE INVENTION

The present invention relates to a device for closing a flow duct, to a pivotable shut-off and/or throttle valve, and to a method for closing a flow duct.

### BACKGROUND INFORMATION

A device is described, for example, in German Published Patent Application No. 199 36 457, which is used for closing an air-guiding flow duct, in particular intake duct, of an internal combustion engine in a sealing manner and includes a pivotable valve shaft which is arranged in the flow duct and to which two diametrically arranged valve wings provided with reinforcements are connected which can be displaced, by pivoting of the valve shaft, into an open position and into a closed position in which they rest against in each case one sealing contour provided in the flow duct, as a result of which the flow duct is closed in a sealing manner. The sealing contours are in each case formed by a sealing ridge which projects into the flow duct and is provided on a seal comprising rubber. Wear of and damage to the seal can occur as a result of rapid and frequent valve movement, with the result that the flow duct can no longer be closed in a sealing manner.

It is an object of the present invention to provide a device, in the case of which at least substantially complete closure or shutting-off of the flow duct may be ensured even after relatively long use. A further object of the present invention is to provide a shut-off and/or throttle valve which may have a simple construction and may be produced at low cost if necessary. It is also an object of the present invention to provide a method in which sealing shutting-off of the flow duct may be ensured.

### SUMMARY

The above and other beneficial objects of the present invention may be achieved by providing a device, a valve and a method as described herein.

In an example embodiment of a device according to the present invention, the valve wing is of elastic configuration and the sealing contour or the valve wing is arranged such that first of all a region, at a distance from the valve shaft in the radial direction, of the valve wing comes into contact with the sealing contour when the valve wing is being brought into contact with the sealing contour, and that, during further pivoting of the valve shaft, the valve wing is deformed to such an extent that it rests substantially completely against the sealing contour. The valve wing and the sealing contour may not gape apart even in the case of component tolerances and a possible offset of the valve shaft as a result of the elasticity of the valve wing and of the fact that the initial contact of the valve wing never takes place near the valve shaft. The valve wing therefore may bear tightly against the sealing contour, with the result that, e.g., complete, but at least substantially complete, shutting-off/closure of the flow duct may be ensured. The device according to an example embodiment of the present invention may be used in a functionally reliable manner even if there are contaminants, for example, small foreign bodies, in the flow duct. The noise produced during closure of the flow duct may be less than in conventional devices as a result of the fact that the entire sealing surface of the valve wing does not strike the sealing contour simultaneously, but rather the contact between valve wing and sealing contour becomes greater and greater, starting from a relatively small surface region, i.e., it takes place in a temporally offset manner.

According to an example embodiment of the present invention, provision may be made for first of all the free valve-wing end to come into contact with the sealing contour, and for the valve wing, by deformation, to come into substantially complete contact with the sealing contour starting from its radially outer end and progressing inwardly toward the valve shaft. The valve wing therefore gradually comes into contact with the sealing contour from the outside inwardly. This may ensure that the torque which is to be applied to the valve shaft, in order to displace the valve wing into the closed position and to deform it in the process in such a manner that it rests flat against the sealing contour over its entire sealing region, may be relatively small. Furthermore, the valve wing may be prevented from lifting off again from the sealing contour during the deformation process at a location at which it has already previously rested in a sealing manner.

The at least one valve wing may have a very low mass in order to keep the mass inertia forces low, but may nevertheless be of robust construction despite its elasticity. In an example embodiment, the valve wing is very thin and consists of a resilient material, for example, a plastic or a carbon-fiber-reinforced material (carbon-fiber-reinforced plastic), it being possible for the valve wing to be provided if necessary with a wear-resistant coating at least in the region of its sealing surface which cooperates with the sealing contour or on its entire outer surface. It is also possible to produce the valve wing from metal which is sufficiently elastic given a correspondingly small thickness of the valve wing, in order that the valve wing is deformed in the desired manner when it comes into contact with the sealing contour.

Furthermore, in an exemplary embodiment of the device, the sealing contour and the valve wing have different geometric shapes when the valve wing has been displaced into the open position. According to a first variant example embodiment, provision is made for the valve wing to have the shape of a flat, planar disc in the open position, while the sealing contour is formed by a bearing surface which has a non-planar shape, e.g., a curvature. In the closed position, the flat valve wing butting against the curved bearing surface over its surface area has a corresponding curvature. According to a second variant example embodiment, the valve wing has a curvature in the open position while the bearing surface forming the sealing contour is of planar configuration. This means that the valve wing is bent in such a manner by its contact with the bearing surface in the closed position that it has a flat shape. Other shapes are possible for the valve wing and the sealing contour or the bearing surface.

If the at least one valve wing or the bearing surface is of curved configuration, then the curvature may have a constant profile, i.e., the valve wing or the bearing surface do not have a corrugated shape under any circumstances. Rather, the curvature is of convex or concave configuration with reference to the flow direction of the medium provided in the flow duct.

In an exemplary embodiment of the device, the valve has two, e.g., identically configured valve wings which are arranged diametrically, i.e., lying opposite one another, and which cooperate with in each case one sealing contour. In this example embodiment, the respective valve wing and the associated sealing contour (as seen with the valve wing displaced into the open position) may have identical geometric shapes, e.g., flat or planar. In order to ensure that, even in the case of this example embodiment, in each case one region, lying radially on the outside with respect to the valve shaft, of the valve wings is the first to come into contact with the respective sealing contour, the two sealing contours which extend at least substantially parallel to one another may be arranged at a distance from one another which is greater than the thickness of the valve wings. Small leaks in the region of the valve shaft may be consciously accepted in this case.

In an exemplary embodiment of the device, the bearing surface is formed on the inner circumferential surface of the flow duct. In connection with internal combustion engines, the flow duct may be formed, for example, by an intake pipe which may be manufactured from aluminum. The bearing surface for a valve wing may in this case either be integrally formed into the inner circumferential surface of the flow duct or may be formed by a material-removing machining method. It is also possible to produce the flow duct from plastic or to form it in a housing consisting of plastic. Other example embodiments for realizing the bearing surface in the flow duct are possible, for example, by special insert parts.

In an exemplary embodiment of the device, the bearing region between valve wing and sealing contour may be free of sealing devices. No additional elastic, wear-susceptible seals may therefore be necessary in order to close the flow duct in a sealing manner by the valve, with the result that closure of the flow duct in a sealing manner may be ensured even after relatively long use of the device.

In an exemplary embodiment of the device, the valve wing is configured such that the surface pressure acting on the sealing contour, when the valve wing is arranged in the closed position, is substantially equal across the entire sealing contour given a predeterminable pressure of the medium located in the flow duct. In this manner, it may be possible to ensure a sealing fit up to a defined pressure difference in the case of a valve having two valve wings, one valve wing of which has pressure applied to it, in the closed position of the valve, in the direction of the open position by the medium located in the flow duct, and the other valve wing of which is pressed against the sealing contour. The torque to be applied to the valve shaft, in order to deform the at least one valve wing when it comes into contact with the sealing contour, may be as low as possible.

The above-described device may be used both in connection with gas-guiding, e.g., air-guiding, ducts and also in connection with liquid-guiding ducts.

Further exemplary embodiments of the device may be provided in accordance with combinations of the features described above and set forth below.

In a pivotable shut-off and/or throttle valve according to an example embodiment of the present invention, its at least one valve wing is of resilient configuration in order that it may bear tightly against the sealing contour in the closed position in order to close the flow duct in a sealing manner.

The valve may be used exclusively as a shut-off valve, i.e., it may only be pivoted between an open position in which it opens the flow duct and a closed position in which the flow duct is completely shut off. In the case of another example embodiment, it may be used as a shut-off and throttle valve, i.e., it may therefore also be pivoted into at least one intermediate position lying between the open position and the closed position. The valve according to an example embodiment of the present invention may also be used as a pure throttle valve which is used to variably change the flow cross-section of the flow duct.

In an example embodiment, the at least one valve wing of the shut-off and/or throttle valve is produced in one piece, which may simplify its manufacture. It is also possible to produce the at least one valve wing and the valve shaft in one piece in this example embodiment.

Reference is made to the above and below descriptions regarding further possible arrangements of the shut-off and/or throttle valve. Accordingly, example embodiments of the shut-off and/or throttle valve are also described above and below.

In a method according to an example embodiment of the present invention, the torque to be applied to the valve shaft, in order to bring the at least one elastically configured valve wing into contact with the sealing contour over its surface area/in a sealing manner in the closed position, is so great that, when the valve wing comes into contact with the sealing contour, the valve wing is deformed such that it rests substantially completely against the sealing contour, and the torque is applied to the valve shaft during the entire shut-off procedure in order to hold the valve wing in sealing contact with the sealing contour. In this manner, the formation of gaps between the valve wing and the sealing contour may be prevented at least up to a specific medium pressure in the flow duct.

Example embodiments of the present invention are described in more detail below with reference to the Figures.

### BRIEF DESCRIPTION OF THE DRAWINGS

FIGS. 1 to 3 in each case illustrate an outline sketch of an exemplary embodiment of the device according to the present invention, its valve arranged in a flow duct being represented in different pivoting positions in each Figure.

FIG. 4 illustrates an outline sketch of the device illustrated in FIGS. 1 to 3, its valve shaft provided with two valve wings having a positional tolerance.

FIG. 5 illustrates, on an enlarged scale, an portion labeled “X” in FIG. 4.

### DETAILED DESCRIPTION

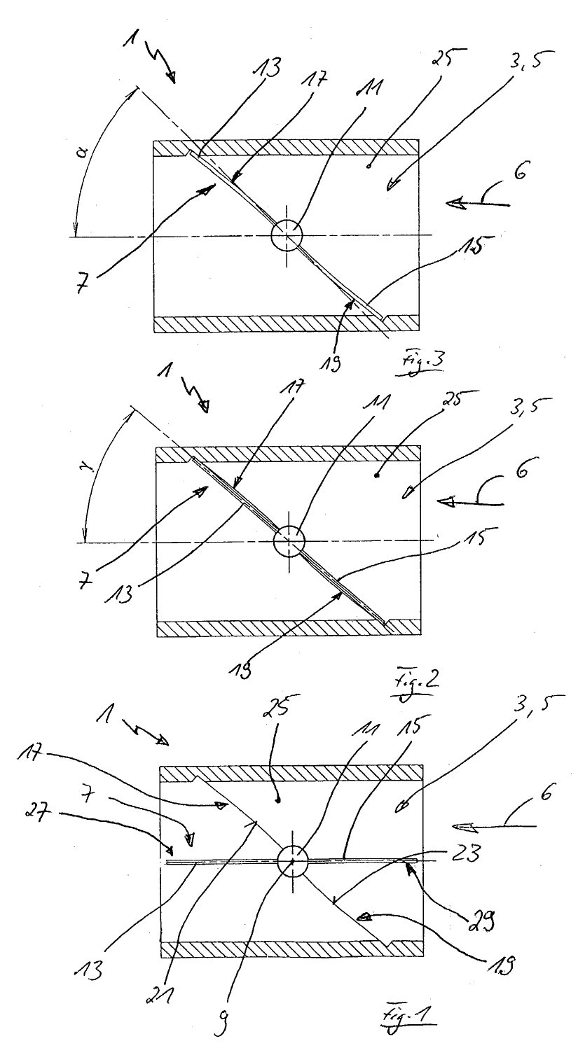

The device, 1 described in the following text with reference to FIGS. 1 to 5 may be used generally for closing a flow duct 3 through which a liquid or gaseous medium may flow. For example, it may be assumed here that the flow duct is an air intake duct 5 of an internal combustion engine. As seen in the flow direction 6 of the air, the air intake duct 5 may be circular in cross-section but may, for example, also be of rectangular configuration.

FIG. 1 illustrates a schematic representation of part of an exemplary embodiment of the device 1 which includes a shut-off valve 7 arranged in the air intake duct 5. The shut-off valve 7 in this case includes a valve shaft 11 which may be pivoted about an axis 9 and to which two valve wings 13 and 15 are attached. The axis 9 is arranged in the center of the air intake duct 5 and extends transversely to the flow direction 6 of the air.

The identically configured valve wings 13, 15 are arranged at the circumference of the valve shaft 11 at a spacing of 180° and extend perpendicularly to the axis 9. The valve wings 13, 15 are of resilient configuration, i.e., they are reversibly deformable, which will be addressed in greater detail in the following text. The valve wings 13, 15 may be produced from plastic or a carbon fiber-reinforced material in order to minimize their weight. It is also possible to manufacture the valve wings 13, 15 from metal or another material which has the desired elasticity properties.

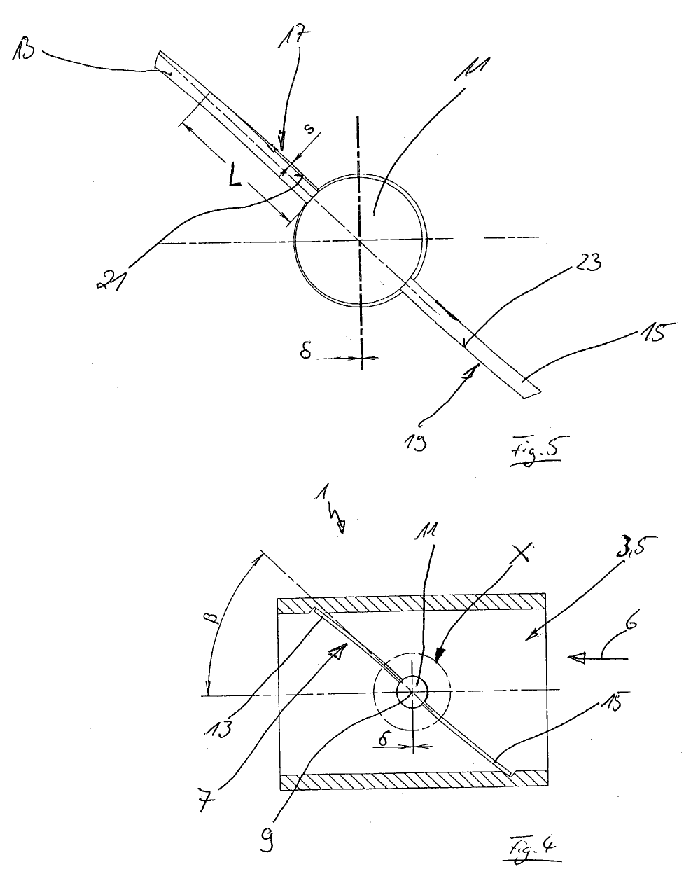

In FIG. 1, the pivotable shut-off valve 7 is arranged in a completely open position in which the free flow cross-section of the air intake duct 5 is at its largest. As illustrated in FIG. 1, the very thin, disc-shaped valve wings 13, 15 are of planar configuration in the open position. The shut-off valve 7 may be pivoted into a completely closed position illustrated in FIG. 3 by a drive device, in which position the air intake duct 5 is completely shut off.

In each case one sealing contour 17 and 19, formed by curved bearing surfaces 21 and 23, are provided in the air intake duct 5 for each of the valve wings 13, 15, respectively. The bearing surfaces 21, 23 have a profile with a constant curvature and are arranged opposite one another in such a manner that a slightly S-shaped profile is obtained as seen in the longitudinal extent of the valve shaft 11. In this case, the bearing surface 21, as seen in the flow direction 6, is convexly curved and the bearing surface 23 is concavely curved. The bearing surfaces 21, 23, extending here at an angle of approximately 45° to the flow direction 6, are formed on the inner circumferential surface 25 of the air intake duct 5 in this exemplary embodiment. The air intake duct 5 consists, for example, of aluminum or plastic, etc.

In order to close the air intake duct 5, the shut-off valve 7 is pivoted clockwise into its closed position (FIG. 3) starting from its open position (FIG. 1). A torque is applied to the valve shaft 11 by the drive device for this purpose. Since the resiliently configured valve wings 13, 15 are of planar configuration and the bearing surfaces 21, 23 are of curved configuration, the entire sealing surface, lying in the edge region, of the shut-off valve 7 does not strike the sealing contours 17, 19 or the bearing surfaces 21, 23 simultaneously, but rather the contact takes place in a temporally offset manner. The curvature of the bearing surfaces 21, 23 is selected such that, starting from the open position, at first only the free valve-wing ends 27 and 29 come into contact with the sealing contours 17, 19, as illustrated in FIG. 2, after the shut-off valve 7 has been pivoted clockwise by an angle γ which in this case is approximately 45°. By the valve shaft 11 being pivoted further, the elastic valve wings 13, 15 are gradually deformed from their radially outer end region inwardly toward the valve shaft 11 as they come into contact with the sealing contours 17, 19. The valve wings 13, 15 rest completely against the sealing contours 17, 19 after the valve shaft 11 has been pivoted by an angle α, with the result that the air intake duct 5 is completely closed, as illustrated in FIG. 3.

As illustrated in FIG. 3, the lower valve wing 15 in this drawing closes in the flow direction 6 of the air, while the upper valve wing 13 closes counter to the flow direction 6. This means that the pressure difference in the air intake duct 5 which builds up after the air intake duct 5 has closed presses the lower valve wing 15 against the sealing contour 19, with the result that closure of the air intake duct 5 in a sealing manner at this location may be readily ensured, while a force directed away from the sealing contour 17 is applied to the upper valve wing 13. However, the valve wing 13 lifting off from the sealing contour 17 may be ruled out with great reliability up to a defined pressure difference on account of the resilient properties of the valve wings 13, 15 and on account of the torque which continues to be applied to the shut-off valve 7 even after the closed position has been reached. As the valve wings 13, 15 bear tightly, as it were, against the sealing contours 17, 19 on account of their elastic properties, as a result of which abutment of the sealing surfaces of the valve wings 13, 15 against the sealing contours 17, 19 over their entire surface and thus closure of the air intake duct 5 in a sealing manner may be ensured, at least relatively small component tolerances may not lead to the valve wings 13, 15 and the respective sealing contour 17 or 19 gaping apart either.

The first contact between the valve wings 13, 15 and the sealing contours 17, 19 may never take place near the valve shaft 11 but instead in a region at a distance from the valve shaft 11 in the radial direction. This may be achieved in the exemplary embodiment illustrated in FIGS. 1 to 3 by the valve wings 13, 15 and the sealing contours 17, 19 having different geometric shapes.

No separate sealing device(s), e.g., consisting of soft materials, may be required between the valve wings 13, 15 and the sealing contours 17, 19 in order to close the air intake duct 5 in a sealing manner. The valve wings 13, 15 rest directly against the sealing contours 17, 19. This may not lead to leaks as a result of wear even in the case of frequent and rapid closing of the air intake duct 5 on account of the configuration according to the invention of the shut-off valve 7.

When the shut-off valve 7 is pivoted back from its closed position (FIG. 3) into the open position again, the valve wings 13, 15 automatically reassume their planar original shape (FIG. 1) on account of their resilient properties.

When the valve wings 13, 15 come into contact with the sealing contours 17, 19, a small relative movement between the valve wings 13, 15 and the respective sealing contour 17 or 19 takes place on account of the valve wings bending. Given a suitable selection of materials for the valve wings 13, 15 and the air intake duct 5, this relative movement may lead to the contact/sealing surface between valve wings 13, 15 and sealing contours 17, 19 bedding in, as it were, as a result of which the sealing action may be further improved and adhesion of contaminants may be prevented.

FIG. 4 illustrates the shut-off valve 7, in the closed position, of the device 1 illustrated in FIGS. 1 to 3, its valve shaft 11 having a positional tolerance δ. The positional tolerance δ leads to a valve wing already resting almost completely against the sealing contour at a pivoting angle β of the valve shaft 11, while a converging gap continues to exist between the other valve wing and its associated sealing contour, as illustrated in FIG. 5 which illustrates, on an enlarged scale, an area X denoted by a dashed line in FIG. 4.

The pivoting angle β, by which the valve shaft 11 may be pivoted, given a positional tolerance δ, into the closed position starting from its completely open position, is smaller than the pivoting angle α without positional tolerance of the valve shaft 11.

It is illustrated in FIG. 5 that the lower valve wing 15 bears substantially completely tightly against the sealing contour 19 or the bearing surface 23, i.e., the sealing surface arranged in the edge region of the valve wing 15 rests almost completely in a sealing manner against the bearing surface 23. The upper valve wing 13 does not rest completely against the sealing contour 17 or the bearing surface 21 on account of the offset of the valve shaft 11. Rather, a gap s extending over a length L exists between the valve wing 13 and the bearing surface 21, the gap, starting from the connecting point of the valve wing 13 at the outer circumference of the valve shaft 11, where the gap is at its largest, converging toward the radially outer end of the valve wing 13. The gap s is only very small, e.g., on account of the reversible deformability according to the present invention of the valve wings and because the valve wings may always initially strike against the sealing contours only with a region at a radial distance from the valve shaft 11, with the result that improved sealing compared with conventional shut-off valves may be ensured even given a positional tolerance δ of the valve shaft 11.

All variant example embodiments of the device 1 have the common feature that the shut-off valve 7, having at least one wing and, e.g., two, is distorted in the closed position, which leads to the at least one elastic valve wing bearing tightly against the sealing contour in the flow duct and thus to the flow duct being closed in a sealing manner.

What is claimed is:

1. A device for closing a flow duct, at least one sealing contour arranged in the flow duct, comprising:
a valve including at least one valve wing arranged to rest against the sealing contour in a closed position; and
a valve shaft configured to pivot the valve between an open position and the closed position;
wherein the valve wing is of elastic configuration, at least one of the valve wing and the sealing contour configured so that a region of the valve wing at a distance from the valve shaft in a radial direction comes into contact with the sealing contour when the valve wing is being brought into contact with the sealing contour and so that during further pivoting of the valve shaft, the valve wing is deformed to such an extent that the valve wing rests substantially completely against the sealing contour.

2. The device according to claim 1, wherein the device is configured as at least one of a shut-off valve and a throttle valve.

3. The device according to claim 1, wherein a free end of the valve wing is arranged to contact with the sealing contour, and the valve wing is configured to deform to come into substantially complete contact with the sealing contour starting from a radially outer end and progressing inwardly toward the valve shaft.

4. The device according to claim 1, wherein the valve wing is formed of a resilient material.

5. The device according to claim 1, wherein the sealing contour and the valve wing have one of identical and different geometric shapes when the valve wing has been displaced into the open position.

6. The device according to claim 1, wherein the valve wing in the open position has a flat, planar disc shape.

7. The device according to claim 1, wherein the valve wing in the open position includes at least one curvature in cross-section.

8. The device according to claim 1, wherein the sealing contour includes a bearing surface having a non-planar shape.

9. The device according to claim 8, wherein the bearing surface includes a curved configuration.

10. The device according to claim 8, wherein the bearing surface includes a planar configuration.

11. The device according to claim 8, wherein the bearing surface corresponds to an inner circumferential surface of the flow duct.

12. The device according to claim 1, wherein a bearing region between the valve wing and the sealing contour is free of sealing devices.

13. The device according to claim 1, wherein the valve wing is configured so that the surface pressure on the sealing contour when the valve wing is in the closed position is substantially equal across the entire sealing contour in accordance with a predeterminable pressure difference across the valve wing of a medium located in the flow duct.

14. The device according to claim 1, wherein the valve includes two diametrically arranged valve wings, each valve wing arranged to cooperate with a respective sealing contour.

15. The device according to claim 14, wherein the two sealing contours extend at least substantially parallel to one another and are arranged at a distance from one another greater than a thickness of the valve wings.

16. The device according to claim 1, wherein the flow duct includes an air duct of an internal combustion engine.

17. The device according to claim 1, wherein the flow duct includes an air intake duct of an internal combustion engine.

18. A pivotable valve arranged as at least one of a shut-off and a throttle valve, comprising:
at least one valve wing configured to rest against a sealing contour in a closed position, the sealing contour provided in a flow duct, the valve element of resilient configuration.

19. The valve according to claim 18, wherein the valve wing is formed of one piece.

20. The valve according to claim 18, wherein the valve wing is configured so that a region of the valve wing at a distance from a valve shaft in a radial direction comes into contact with the sealing contour when the valve wing is being brought into contact with the sealing contour and so that during further pivoting of the valve shaft, the valve wing is deformed to an extent that the valve wing rests substantially completely against the sealing contour.

21. A method for closing a flow duct by a device that includes a valve pivotable between an open position and a closed position by a valve shaft, the valve including at least one elastically-configured valve wing that, in a closed position, rests against a sealing contour arranged in the flow duct to completely shut off the flow duct, comprising:
providing a torque that is so high that, when the elastically-configured valve wing comes into contact with the sealing contour, the valve wing is deformed to rest substantially completely against the sealing contour; and
applying torque to the valve shaft during an entire shut-off procedure to hold the valve wing in sealing contact with the sealing contour.
